(19) United States
(12) Patent Application Publication
(10) Pub. No.: US 2026/0292669 A1
(43) Pub. Date: Sep. 24, 2026

(54) METHOD AND APPARATUS FOR RESELECTION TO CELL WITH PUNCTURED SYNCHRONIZATION SIGNAL AND PHYSICAL BROADCAST CHANNEL BLOCK IN MOBILE COMMUNICATIONS

(71) Applicant: MEDIATEK SINGAPORE PTE. LTD., Singapore (SG)

(72) Inventors: Waseem Hazim Ozan OZAN, Cambridge (GB); Tsang-Wei YU, Hsinchu City (TW); Chiou-Wei TSAI, Hsinchu City (TW); Pradeep JOSE, Cambridge (GB)

(73) Assignee: MEDIATEK SINGAPORE PTE. LTD., Singapore (SG)

(21) Appl. No.: 19/474,672

(22) PCT Filed: Nov. 15, 2024
(86) PCT No.: PCT/CN2024/132179

§ 371 Date: Oct. 10, 2025

Related U.S. Application Data
(60) Provisional application No. 63/600,115, filed on Nov. 17, 2023.

(51) Int. Cl. H04W 48/18

(52) U.S. Cl. CPC H04W 48/18

(57) ABSTRACT

Various solutions for reselection to cell with punctured synchronization signal and physical broadcast channel block (SSB) with respect to user equipment (UE) and network apparatus in mobile communications are described. A UE may receive a system information block (SIB) from a serving cell of a first radio access technology (RAT). The SIB may include a first list indicating at least one neighbor cell of a second RAT with an SSB after puncturing. The UE may perform a cell reselection procedure based on the first list in an event that the UE supports a cell of the second RAT with a channel bandwidth less than 5 megahertz (MHz). By including a separate list in the SIB that indicates neighbor cells with punctured SSB, reselection to such neighbor cells by an uncapable UE can be prevented.

### CROSS REFERENCE TO RELATED PATENT APPLICATION(S)

The present disclosure is part of a non-provisional application claiming the priority benefit of U.S. Patent Application No. 63/600,115, filed 17 Nov. 2023, the content of which herein being incorporated by reference in its entirety.

### TECHNICAL FIELD

The present disclosure is generally related to mobile communications and, more particularly, to reselection to cell with punctured synchronization signal and physical broadcast channel block (SSB) with respect to user equipment and network apparatus in mobile communications.

### BACKGROUND

Unless otherwise indicated herein, approaches described in this section are not prior art to the claims listed below and are not admitted as prior art by inclusion in this section.

Cell reselection is a mechanism that allows idle or inactive user equipments (UEs) to optimize their network connection by selecting the most suitable cell to connect to. Inter-radio access technology (inter-RAT) cell reselection allows UEs to switch between cells that use different RATs, so as to ensure seamless connectivity and optimal performance as UEs moves from one coverage area to another.

As communication technology evolves, some fifth generation (5G) new radio (NR) cells may support a channel bandwidth less than 5 megahertz (MHz). However, no robust mechanism currently exists to preclude UEs incapable of supporting cells with the bandwidth less than 5 MHz from selecting such cells during cell reselection. Therefore, there is a need to provide proper schemes to address the above-described issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to reselection to cell with punctured synchronization signal and physical broadcast channel block (SSB) with respect to user equipment (UE) and network apparatus in mobile communications.

In one aspect, a method may involve an apparatus receiving a system information block (SIB) from a serving cell of a first radio access technology (RAT). The SIB may include a first list indicating at least one neighbor cell of a second RAT with an SSB after puncturing. The method may also involve the apparatus performing a cell reselection procedure based on the first list in an event that the apparatus supports a cell of the second RAT with a channel bandwidth less than 5 megahertz (MHz).

In one aspect, an apparatus may comprise a transceiver which, during operation, wirelessly communicates with a network node. The apparatus may also comprise a processor communicatively coupled to the transceiver. The processor, during operation, may perform operations comprising receiving a SIB from a serving cell of a first RAT via the transceiver. The SIB may include a first list indicating at least one neighbor cell of a second RAT with an SSB after puncturing. The processor may also perform operations comprising performing a cell reselection procedure based on the first list in an event that the apparatus supports a cell of the second RAT with a channel bandwidth less than 5 MHz.

In another aspect, a method may involve a network node of a first RAT generating a SIB. The SIB may include a first list indicating at least one neighbor cell of a second RAT with an SSB after puncturing. The method may also involve the network node transmitting the SIB to a UE.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IOT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example of SSB after puncturing in accordance with the present disclosure may be implemented.

FIG. 3A is a diagram depicting an example scenario of SIB24 information element in accordance with implementations of the present disclosure.

FIG. 3B is a diagram depicting another example scenario of SIB24 information element in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reselection to cell with punctured synchronization signal and physical broadcast channel block (SSB or SS/PBCH block) in mobile communications, ensuring that user equipments (UEs) incapable of supporting cells with bandwidth less than 5 megahertz (MHz) do not attempt to reselect to these cells. According to the present disclosure, a number of possible solutions may be implemented separately or jointly. That is, although these possible solutions may be described below separately, two or more of these possible solutions may be implemented in one combination or another.

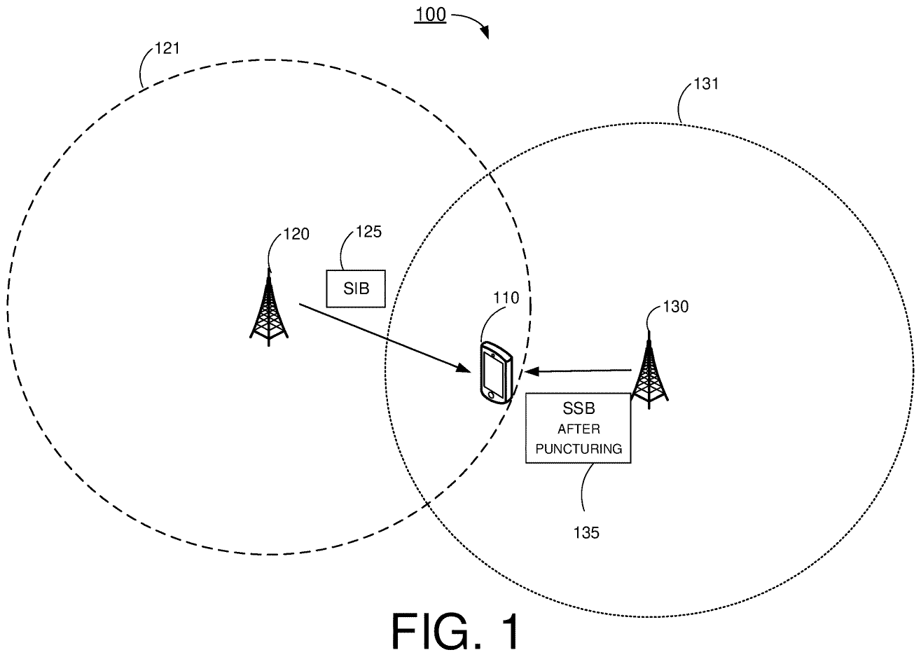

FIG. 1 is a diagram depicting an example scenario of a communication environment in which various solutions and schemes in accordance with the present disclosure may be implemented. In scenario 100, a UE 110 is currently camping on a cell 121 of a base station (BS) 120, the cell 121 is the serving cell of the UE 110. The BS 120 may broadcast system information including crucial parameters needed by the UE 110 to access network. In one example, the BS 120 may be an Evolved Node B (eNB) in the long-term evolution (LTE) access network (i.e., the evolved universal terrestrial radio access (E-UTRA) network). The system information broadcasted by the BS 120 may include a system information block (SIB) 125 providing information about the neighbor cells. When the UE 110 operating in the E-UTRA network (E-UTRAN) is in an idle or inactive mode, it may perform a cell reselection procedure based on the SIB 125. The SIB 125 may include a specific list indicating one or more particular neighbor cells. In one embodiment, the particular neighbor cell may be a fifth generation (5G) new radio (NR) cell with a channel bandwidth less than 5 MHz. In scenario 100, a BS 130 is a 5G next Generation Node B (gNB) and the channel bandwidth thereof is less than 5 MHz, thus the cell 131 is indicated by the specific list in the SIB 125.

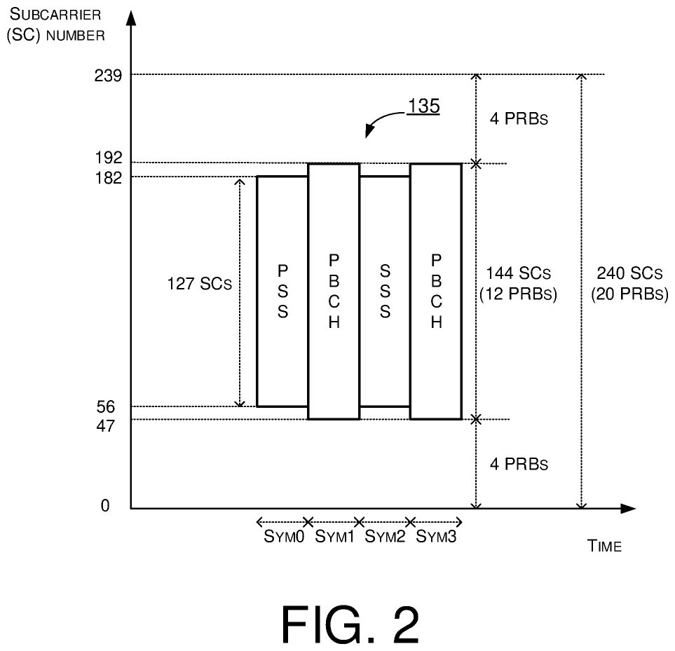

In current mechanism, the synchronization signal and physical broadcast channel block (SSB) in 5G NR is 20 physical resource blocks (PRBs or RBs) in frequency and 4 orthogonal frequency-division multiplexing (OFDM) symbols in time. Out of which, the physical broadcast channel (PBCH) has 20 PRBs bandwidth and is transmitted on subcarriers 0 to 239. The primary synchronization signal (PSS) and secondary synchronization signal (SSS) transmitted on subcarriers 56 to 182 is about 12 PRBs including guard band. However, as NR operations associated with the BS 130 is less than 5 MHz, the PBCH bandwidth is required to be truncated to fit within the bandwidth of the NR cell 131. That is, the UE 110 is not expected to receive subcarriers 0 to 47 and 192 to 239 in any of the 4 OFDM symbols of the SSB transmitted by the BS 130. In the present disclosure, the SSB after puncturing is an SSB including the PSS, the SSS, and the truncated PBCH. To be specific, as shown in FIG. 2, the SSB after puncturing 135 transmitted by the BS 130 includes the PSS in the first symbol Sym0, the SSS in the third symbol Sym2, and the truncated PBCH in the second and fourth symbols Sym1 and Sym3. In this embodiment, the truncated PBCH has 12 PRBs bandwidth. Alternatively, the truncated PBCH may be a PBCH having a bandwidth less than 20 PRBs (e.g., 15 PRBs).

To select the best cell to connect to while in the idle or inactive mode, the UE 110 may perform a cell reselection procedure. In an event that the UE 110 supports NR cells with the channel bandwidth less than 5 MHz, the UE 110 may perform the inter radio access technology (inter-RAT) cell reselection and the relevant operations based on the specific list in the SIB 125. For example, the UE 110 operating in E-UTRAN may search for and measure the NR neighbor cell(s) indicated by the specific list in the SIB 125 and reselect one NR neighbor cell to camp on. In another example, when the UE 110 operating in E-UTRAN is performing reselection to an NR neighbor cell with the SSB after puncturing, the UE 110 may reselect to those NR neighbor cells indicated by the specific list in the SIB 125. In still another example, when the UE 110 operating in E-UTRAN is performing cell reselection to an NR neighbor cell with the SSB after puncturing, the UE 110 may measure and/or reselect to NR neighbor cells indicated by the specific list in the SIB 125. It should be noted that, the specific list in the SIB 125 should be checked by the UE 110 only if the UE 110 supports NR cells with the channel bandwidth less than 5 MHz. When the UE 110 decides to reselect to a target NR neighbor cell 131 supporting the bandwidth less than 5 MHZ, the UE 110 may read the truncated PBCH included in the the SSB after puncturing 135.

In one embodiment, the SIB 125 may be a system information block type24 (SIB24), the information element (IE) of SIB24 may contain information relevant for inter-RAT cell reselection (i.e., the information about NR frequencies and NR neighbor cells relevant for cell reselection) for neighbor cells with bandwidth less than 5 MHz. The SIB 125 may also be used for NR idle/inactive measurements by the UE 110 if the UE 110 supports NR cells with the channel bandwidth less than 5 MHz. The IE may include cell reselection parameters common for a frequency.

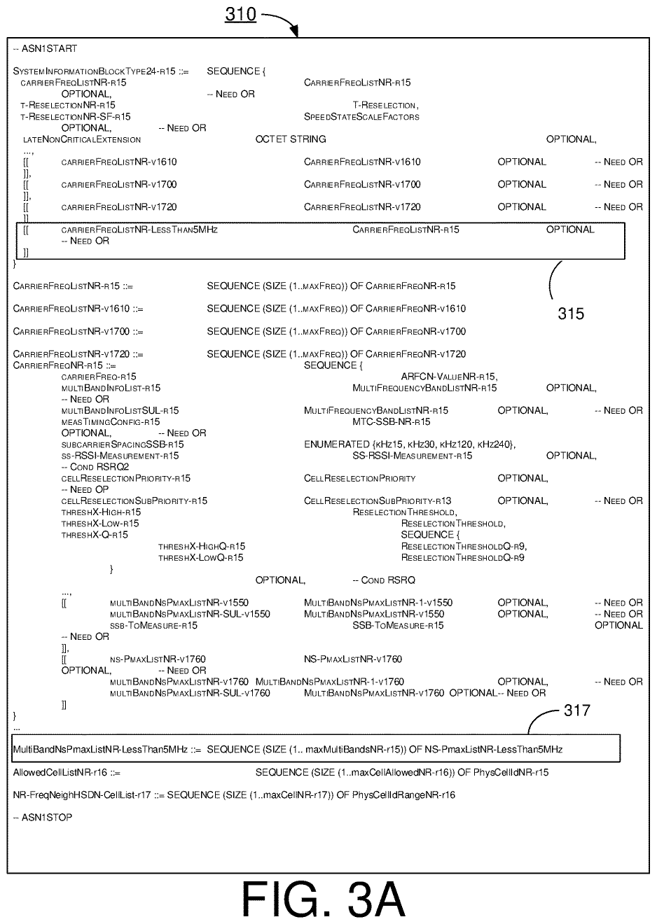

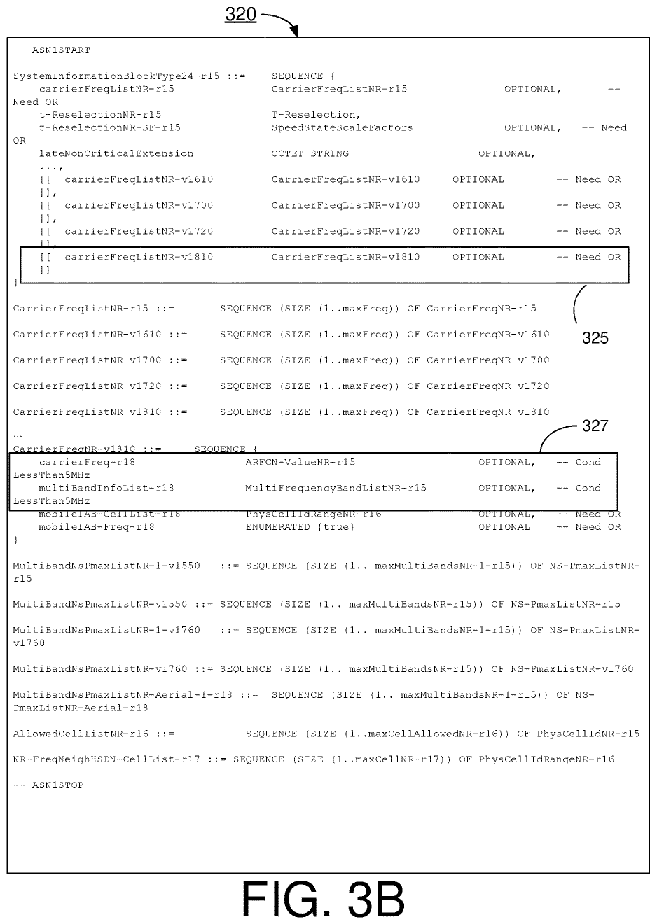

FIG. 3A is a diagram depicting an example scenario of SIB24 IE in accordance with implementations of the present disclosure. In scenario 310, the specific list in the SIB 125 for indicating the NR neighbor cell(s) with SSB after puncturing may be a list of carrierFreqListNR-LessThan5 MHz depicted by 315, and the related configuration for the NR frequency band(s) listed in the carrierFreqListNR-Less Than5 MHz may be indicated in a list of MultiBandNsPmaxListNR-LessThan5 MHz as depicted by 317. In scenario 310, the list of MultiBandNsPmaxListNR-LessThan5 MHz has a field of LessThan5 MHz. When the UE 110 supports NR cells with the channel bandwidth less than 5 MHz, it may check the list of carrierFreqListNR-LessThan5 MHz, measure the NR neighbor cells indicated by the list of carrierFreqListNR-LessThan5 MHz, and select one NR neighbor to camp on.

FIG. 3B is a diagram depicting another example scenario of SIB24 IE in accordance with implementations of the present disclosure. In scenario 320, the specific list in the SIB 125 for indicating the NR neighbor cell(s) with SSB after puncturing may be a list of carrierFreqListNR-v1810 depicted by 325. In this embodiment, the entries of carrierFreq-r18 and multiBandInfoList-r18 associated with the list of carrierFreqListNR-v1810 comprises a field of Less Than5 MHz as depicted by 327. In this embodiment, the signaling of carrierFreq-r18 and multiBandInfoList-r 18 for NR cells with less than 5 MHz bandwidth is added in the SIB24. When the UE 110 supports NR cells with the channel bandwidth less than 5 MHz, it may check the list of carrierFreqListNR-v1810, measure the NR neighbor cells indicated by the list of carrierFreqListNR-v1810, and select one NR neighbor to camp on.

In another embodiment, when the UE 110 operating in E-UTRAN supports NR cells with channel bandwidth less than 5 MHz and is performing a radio resource management (RRM) measurement on NR neighbor cells with the SSB after puncturing (e.g., the cell 131 with the SSB after puncturing 135, which includes the truncated PBCH having a bandwidth less than 20 PRBs), the UE 110 may measure those inter-RAT/NR cells indicated by the specific list in the SIB 125.

Besides the specific list for indicating the NR neighbor cell(s) with SSB after puncturing, the SIB 125 may also include another list for indicating the NR neighbor cell(s) without SSB after puncturing. That is, the SIB 125 may include a first list for indicating the NR neighbor cell(s) with SSB after puncturing along with a second list for indicating the NR neighbor cell(s) without SSB after puncturing. In an event that the UE 110 supports NR cells with channel bandwidth less than 5 MHz, the UE 110 may perform the cell reselection procedure and the RRM measurement based on the first list. However, in an event that the UE 110 does not support NR cells with channel bandwidth less than 5 MHz, the UE 110 may perform the cell reselection procedure and the RRM measurement based on the second list.

By including a separate list in the SIB that indicates neighbor cells with SSB after puncturing, the network can ensure that these cells can only be reselected by UEs capable of supporting cells less than 5 MHz.

### Illustrative Implementations

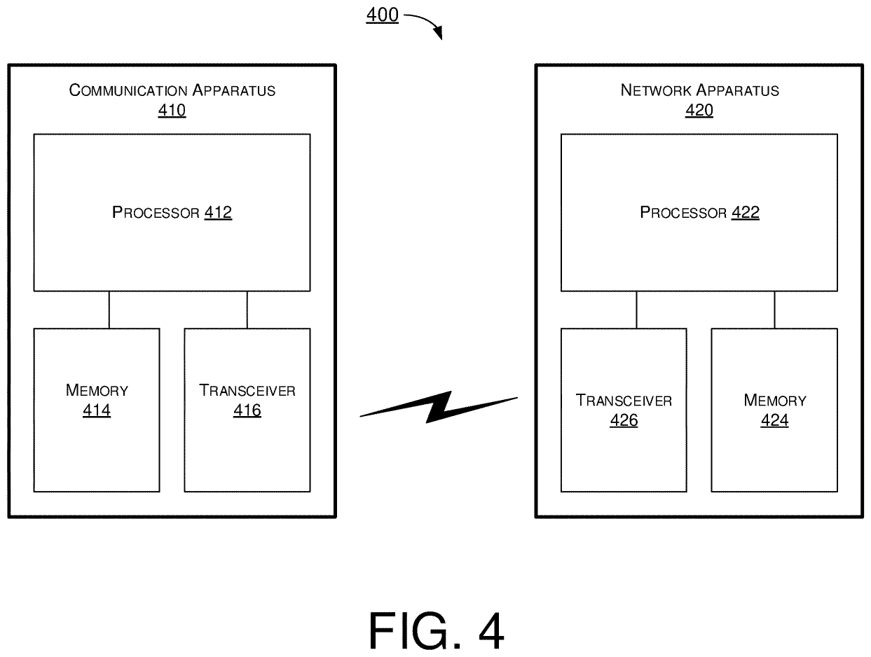

FIG. 4 illustrates an example communication system 400 having at least an example communication apparatus 410 and an example network apparatus 420 in accordance with an implementation of the present disclosure. Each of the communication apparatus 410 and network apparatus 420 may perform various functions to implement schemes, techniques, processes and methods described herein pertaining to reselection to cell with punctured SSB in mobile communications, including scenarios/schemes described above as well as process 500 and process 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNB in an LTE network. Network apparatus 420 may include at least some of those components shown in FIG. 4 such as a processor 422, for example. Processor 422 may further include protocol stacks and a set of control functional modules and circuit. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of the processor 412 and processor 422 may be implemented in the form of one or more single-core processors, one or more multi-core processors, or one or more CISC processors. That is, even though a singular term “a processor” is used herein to refer to processor 412 and processor 422, each of the processor 412 and processor 422 may include multiple processors in some implementations and a single processor in other implementations in accordance with the present disclosure. In another aspect, each of the processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and processor 422 is a special-purpose machine specifically designed, arranged and configured to perform specific tasks in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein.

In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

For illustrative purposes and without limitation, descriptions of capabilities of the communication apparatus 410 and network apparatus 420 are provided below with process 500 and process 600. In which, communication apparatus 410 is implemented in or as a communication apparatus or a UE, and network apparatus 420 is implemented in or as a network node of a communication network (e.g., a base station).

### Illustrative Processes

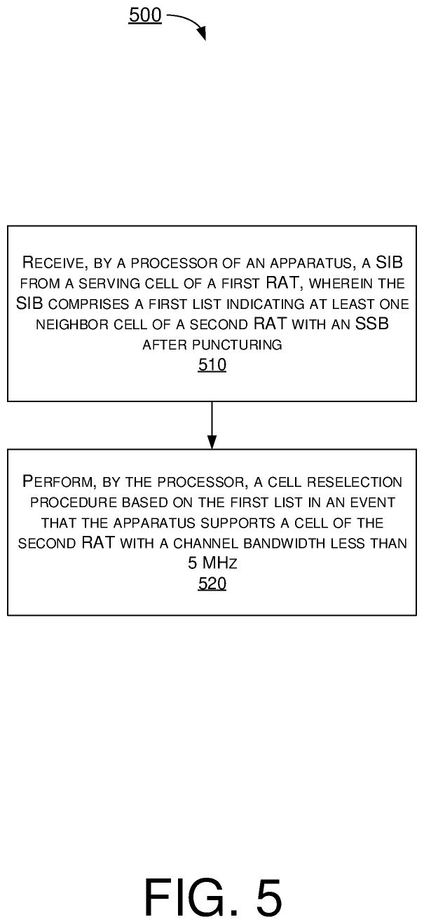

FIG. 5 illustrates an example process 500 in accordance with an implementation of the present disclosure. Process 500 may be an example implementation of above scenarios/schemes, whether partially or completely, with respect to reselection to cell with punctured SSB in mobile communications. Process 500 may represent an aspect of implementation of features of communication apparatus 410. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE (e.g., the UE 110) or machine type devices. Solely for illustrative purposes and without limitation, process 500 is described below in the context of communication apparatus 410 as a UE. Process 500 may begin at block 510.

At block 510, process 500 may involve processor 412 of communication apparatus 410 receiving a SIB from a serving cell of a first RAT via transceiver 416. The SIB may include a first list indicating at least one neighbor cell of a second RAT with an SSB after puncturing. The SSB may also referred to as the SS/PBCH block. To be specific, the SSB (or the SS/PBCH block) after puncturing is an SSB with the truncated PBCH having a bandwidth less than 20 PRB. Process 500 may proceed from block 510 to block 520.

At block 520, process 500 may involve processor 412 performing a cell reselection procedure based on the first list in an event that communication apparatus 410 supports a cell of the second RAT with a channel bandwidth less than 5 MHz.

In some implementations, when performing the cell reselection procedure, process 500 may involve processor 412 searching for and measuring the at least one neighbor cell indicated by the first list. Also, process 500 may involve processor 412 reselecting from the serving cell to one of the at least one neighbor cell indicated by the first list.

In some implementations, process 500 may further involve processor 412 performing a RRM measurement based on the first list in an event that communication apparatus 410 supports the cell of the second RAT with the channel bandwidth less than 5 MHz.

In some implementations, the SIB may further include a second list indicating at least one neighbor cell of the second RAT without the SSB after puncturing. Process 500 may further involve processor 412 performing the cell reselection procedure based on the second list in an event that communication apparatus 410 does not support the cell of the second RAT with the channel bandwidth less than 5 MHz

In some implementations, the first RAT may include an E-UTRA.

In some implementations, the second RAT may include a 5G NR.

In some implementations, the first list may include a list of carrierFreqListNR-v1810.

In some implementations, at least one of carrierFreq-r18 and multiBandInfoList-r18 associated with the list of carrierFreqListNR-v1810 may include a field of LessThan5 MHz.

In some implementations, the SIB may include a system information block type24 (SIB24).

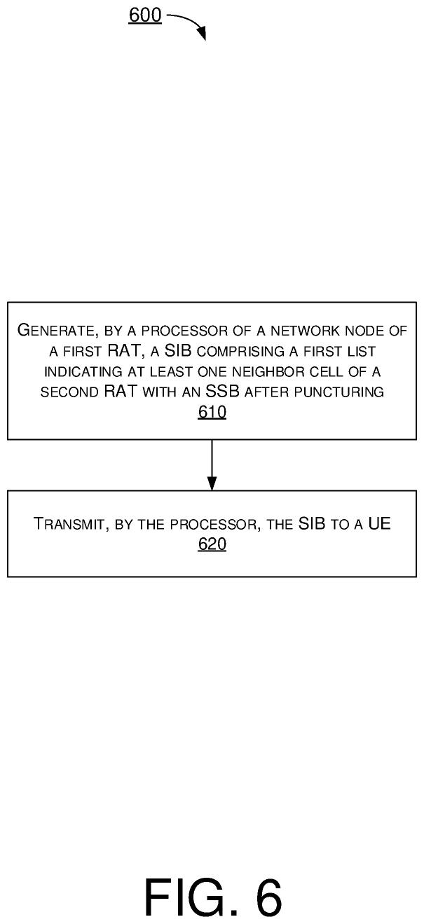

FIG. 6 illustrates another example process 600 in accordance with an implementation of the present disclosure. Process 600 may be an example implementation of above scenarios/schemes, whether partially or completely, with respect to reselection to cell with punctured SSB in mobile communications. Process 600 may represent an aspect of implementation of features of network apparatus 420 or any suitable network node (e.g., the BS 120). Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may begin at block 610.

At block 610, process 600 may involve processor 422 of network apparatus 420 generating a SIB comprising a first list indicating at least one neighbor cell of a second RAT with an SSB after puncturing. The SSB may also referred to as the SS/PBCH block. The SSB (or the SS/PBCH block) after puncturing is equivalent to the SSB with truncated PBCH (i.e., the PBCH having a bandwidth less than 20 PRBs). Process 600 may proceed from block 610 to block 620.

At block 620, process 500 may involve processor 422 transmitting, via transceiver 426, the SIB to a UE (e.g., communication apparatus 410 or the UE 110).

In some implementations, the SIB may further include a second list indicating at least one neighbor cell of the second RAT without the SSB after puncturing.

In some implementations, the first RAT may include an E-UTRA, and the second RAT may include a 5G NR.

In some implementations, the first list may include a list of carrierFreqListNR-v1810. The SIB may include a system information block type24 (SIB24).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a system information block (SIB) from a serving cell of a first radio access technology (RAT), wherein the SIB comprises a first list indicating at least one neighbor cell of a second RAT with a synchronization signal and physical broadcast channel block (SSB) after puncturing; and
performing, by the processor, a cell reselection procedure based on the first list in an event that the apparatus supports a cell of the second RAT with a channel bandwidth less than 5 megahertz (MHz).

2. The method of claim 1, wherein the performing of the cell reselection procedure comprises:
searching for and measuring the at least one neighbor cell indicated by the first list; and
reselecting from the serving cell to one of the at least one neighbor cell indicated by the first list.

3. The method of claim 1, further comprising:
performing, by the processor, a radio resource management (RRM) measurement based on the first list in an event that the apparatus supports the cell of the second RAT with the channel bandwidth less than 5 MHz.

4. The method of claim 1, wherein the SIB further comprises a second list indicating at least one neighbor cell of the second RAT without the SSB after puncturing, and the method further comprises:
performing, by the processor, the cell reselection procedure based on the second list in an event that the apparatus does not support the cell of the second RAT with the channel bandwidth less than 5 MHz.

5. The method of claim 1, wherein the first RAT comprises an evolved universal terrestrial radio access (E-UTRA).

6. The method of claim 1, wherein the second RAT comprises a fifth generation (5G) new radio (NR).

7. The method of claim 6, wherein the first list comprises a list of carrierFreqListNR-v1810.

8. The method of claim 7, wherein at least one of carrierFreq-r18 and multiBandInfoList-r18 associated with the list of carrierFreqListNR-v1810 comprises a field of Less Than5 MHz.

9. The method of claim 6, wherein the SIB comprises a system information block type24 (SIB24).

10. An apparatus, comprising:
a transceiver which, during operation, communicates wirelessly; and
a processor communicatively coupled to the transceiver such that, during operation, the processor performs operations comprising:
receiving, via the transceiver, a system information block (SIB) from a serving cell of a first radio access technology (RAT), wherein the SIB comprises a first list indicating at least one neighbor cell of a second RAT with a synchronization signal and physical broadcast channel block (SSB) after puncturing; and
performing a cell reselection procedure based on the first list in an event that the apparatus supports a cell of the second RAT with a channel bandwidth less than 5 megahertz (MHz).

11. The apparatus of claim 10, wherein the performing of the cell reselection procedure comprises:
searching for and measuring the at least one neighbor cell indicated by the first list; and
reselecting from the serving cell to one of the at least one neighbor cell indicated by the first list.

12. The apparatus of claim 10, wherein, during operation, the processor further performs operations comprising:
performing a radio resource management (RRM) measurement based on the first list in an event that the apparatus supports the cell of the second RAT with the channel bandwidth less than MHz.

13. The apparatus of claim 10, wherein the SIB further comprises a second list indicating at least one neighbor cell of the second RAT without the SSB after puncturing, and during operation, the processor further performs operations comprising:
performing the cell reselection procedure based on the second list in an event that the apparatus does not support the cell of the second RAT with the channel bandwidth less than 5 MHz.

14. The apparatus of claim 10, wherein the first RAT comprises an evolved universal terrestrial radio access (E-UTRA).

15. The apparatus of claim 10, wherein the second RAT comprises a fifth generation (5G) new radio (NR).

16. The apparatus of claim 15, wherein the first list comprises a list of carrierFreqListNR-v1810.

17. The apparatus of claim 16, wherein at least one of carrierFreq-r18 and multiBandInfoList-r18 associated with the carrierFreqListNR-v1810 comprises a field of Less Than5 MHz.

18. The apparatus of claim 15, wherein the SIB comprises a system information block type24 (SIB24).

19. A method, comprising:
generating, by a processor of a network node of a first radio access technology (RAT), a system information block (SIB) comprising a first list indicating at least one neighbor cell of a second RAT with a synchronization signal and physical broadcast channel block (SSB) after puncturing; and
transmitting, by the processor, the SIB to a user equipment (UE).

20. The method of claim 19, wherein:
the SIB further comprises a second list indicating at least one neighbor cell of the second RAT without the SSB after puncturing;
the first RAT comprises an evolved universal terrestrial radio access (E-UTRA);
the second RAT comprises a fifth generation (5G) new radio (NR);
the first list comprises a list of carrierFreqListNR-v1810; and
the SIB comprises a system information block type24 (SIB24).
